(19) United States
(12) Patent Application Publication
(10) Pub. No.: US 2015/0058141 A1
(43) Pub. Date: Feb. 26, 2015

(54) DETECTION AND MITIGATION OF ON-LINE ADVERTISEMENT ABUSE

(71) Applicant: ClarityRay Solutions Ltd., Rishon Lezion (IL)

(72) Inventors: Ido Zvi Yablonka, Rishon Lezion (IL); Vadim Zak, Kiryat Yam (IL); Evgeny Pitelko, Rosh Haayin (IL); Dudi Baruch, Yavne (IL); Saar Wilf, Tel Aviv (IL)

(73) Assignee: CLARITYRAY SOLUTIONS LTD., Rishon Lezion (IL)

(21) Appl. No.: 14/383,415

(22) PCT Filed: Mar. 5, 2013
(86) PCT No.: PCT/IB2013/051723

§ 371 Date: Sep. 5, 2014

Related U.S. Application Data
(60) Provisional application No. 61/607,493, filed on Mar. 6, 2012.
(60) Provisional application No. 61/749,948, filed on Jan. 8, 2013.
(60) Provisional application No. 61/750,368, filed on Jan. 9, 2013.
(60) Provisional application No. 61/750,861, filed on Jan. 10, 2013.

(51) Int. Cl. G06Q 30/02; G06F 17/22

(52) U.S. Cl. CPC G06Q 30/0277; G06F 17/2288
USPC 705/14.73

(57) ABSTRACT

Detecting and mitigating advertisement abuse software on a user device includes producing a digital document comprising a specification for a default advertisement and content. Advertisement abuse software for preventing the default advertisement from being displayed as specified on the user device is detected based on a test associated with one or more test elements. A specification for embedding an alternative advertisement in the digital document is generated, so as to prevent detection by advertisement abuse software, and a display of one of the default advertisement and the alternative advertisement is facilitated on the user device based on whether advertisement abuse software is detected.

### CROSS-REFERENCE TO RELATED APPLICATIONS

This application claims the benefit of U.S. Provisional Patent Application 61/607,493, filed Mar. 6, 2012, U.S. Provisional Patent Application 61/749,948, filed Jan. 8, 2013, U.S. Provisional Patent Application 61/750,368, filed Jan. 9, 2013, and U.S. Provisional Patent Application 61/750,861, filed Jan. 10, 2013, whose disclosures are incorporated herein by reference.

### FIELD OF THE INVENTION

The present invention relates generally to on-line advertising, and particularly to methods and systems for detecting and mitigating advertising abuse.

### BACKGROUND OF THE INVENTION

Providers of digital content often embed advertisements in the content they provide to users. Some users employ Ad-Blocking Software (ABS) that prevents viewing of advertisements. Examples of ABS include, for example, browser plug-ins such as Ad-Block, Ad-Block Plus and EasyBlock. Some browsers or readers, such as Safari Reader and Clearly, include advertisement stripping functionality. The use of ABS causes considerable financial and other damage to Content Providers (CPs).

U.S. Patent Application Publication 2008/0319862, whose disclosure is incorporated herein by reference, describes methods for preventing ad stripping from ad-supported digital content. The methods include removing part of the content, and using a digital rights management (DRM) proxy server to provide links to any removed content part and to ads to be inserted in the content to a player who plays the content with the ads. The DRM proxy server ensures that the player cannot distinguish between removed content parts and the ads. A system enabling the method includes in addition to the DRM server and player an encoder used to remove at least one part from the content, encode the remaining content and the removed part and supplying links to each removed part to the DRM proxy server. The system further includes an ad server used to provide links to ads to the DRM proxy server.

### SUMMARY OF THE INVENTION

An embodiment of the present invention that is described herein provides a method, which includes providing to a user device executable code that runs on the user device, verifies whether the user device runs abuse software for abusing display of an advertisement, and chooses whether to display the advertisement or an alternative advertisement depending on whether the user device runs the abuse software.

In some embodiments, providing the executable code includes producing a digital document that specifies at least the advertisement and content, both to be displayed on the user device, embedding the executable code in the digital document, and serving the digital document, including the embedded executable code, to the user device. In some embodiments, producing the digital document includes embedding the alternative advertisement in the digital document. In other embodiments, providing the executable code includes causing the user device to obtain the executable code prior to displaying a digital document that includes the advertisement.

In an embodiment, the executable code causes display of the alternative advertisement upon finding that the user device runs the abuse software. In an alternative embodiment, the user device is configured to display by default both the advertisement and the alternative advertisement, and the executable code inhibits display of the alternative advertisement upon finding that the user device does not run the abuse software.

In a disclosed embodiment, the advertisement is to be displayed with a digital document, and the alternative advertisement is embedded in the digital document using a format that prevents the abuse software from detecting the alternative advertisement. Embedding the alternative advertisement may include repeatedly modifying an attribute of the alternative advertisement in the digital document, so as to prevent detection by the abuse software.

In another embodiment, the advertisement is to be displayed with a digital document, and the executable code performs at least one test that verifies whether the advertisement is indeed displayed as specified in the digital document. In yet another embodiment, the executable code verifies whether the user device runs the abuse software by performing a composite test that combines at least two individual tests relating to respective different points in time. In still another embodiment, the executable code stores at least one test result locally on the user device.

In an embodiment, the executable code verifies whether the user device runs the abuse software by performing a composite test that depends on at least one test result stored locally on the user device. In another embodiment, the executable code verifies whether the user device runs the abuse software by performing a composite test that depends on information obtained from a system remote from the user device. In yet another embodiment, the advertisement is to be displayed with a digital document, the method includes embedding in the digital document a model of a legitimately-displayed version of the digital document, and the executable code verifies whether the user device runs the abuse software by comparing the digital document to the model.

In an embodiment, the executable code verifies whether the advertisement was blocked by advertisement blocking software. In another embodiment, the executable code verifies whether a rogue element was added by Hijacking and Injection Software (HIS).

There is additionally provided, in accordance with an embodiment of the present invention, a method including producing a digital document including content to be displayed on a user device, which potentially runs advertisement abuse software that detects advertisements using one or more rules. An advertisement is embedded in the digital document using a format that is derived from the rules and prevents the advertisement abuse software from detecting the advertisement using the rules. The digital document, including the content and the embedded advertisement, is served to the user device. Embedding the advertisement may include repeatedly modifying an attribute of the advertisement in the digital document, so as to prevent detection by the abuse software.

There is also provided, in accordance with an embodiment of the present invention, a method including configuring multiple advertisement servers in a cascade, such that an advertisement server that serves empty advertisements is positioned first in the cascade. Upon receiving a request to serve advertisement for a document to be displayed to a user on a user device, verification is made whether the user is subscribed for a service that provides advertisement-free documents. If the user is subscribed for the service, only an empty ad is served to the user device from the advertisement server positioned first in the cascade.

There is further provided, in accordance with an embodiment of the present invention, a method including configuring a system of an advertisement decision-maker with a software component that identifies whether a user is subscribed for a service that provides advertisement-free documents, and identifies one or more content providers with which the user is subscribed for the service Upon receiving in the system a request from a content provider to serve an advertisement to the user, verification is made using the software component whether the user is subscribed for the service with the content provider. If the user is subscribed for the service with the content provider, the request is responded to with an empty advertisement. In some embodiments, the system includes an advertisement network, an advertisement server, an advertisement exchange, an on-line video platform (OVP) and/or a sell side platform (SSP).

There is additionally provided, in accordance with an embodiment of the present invention, a method including offering to users a single-sign-on (SSO) subscription service that is shared by multiple content providers. Internet-page impressions, made by the users while using the subscription service, are monitored. Revenues of the subscription service are shared among the content providers depending on the monitored Internet-page impressions.

There is also provided, in accordance with an embodiment of the present invention, apparatus including a processor and an interface. The processor is configured to hold executable code that is designed to run on a user device, verify whether the user device runs abuse software for abusing display of an advertisement, and choose whether to display the advertisement or an alternative advertisement depending on whether the user device runs the abuse software. The interface is configured to provide the executable code to a user device.

There is additionally provided, in accordance with an embodiment of the present invention, apparatus including a processor and an interface. The processor is configured to produce a digital document including content, to be displayed on a user device that potentially runs advertisement abuse software, which detects advertisements using one or more rules, and to embed in the digital document an advertisement using a format that is derived from the rules and prevents the advertisement abuse software from detecting the advertisement using the rules. The interface is configured to serve the digital document, including the content and the embedded advertisement, to the user device.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for detecting and mitigating advertisement abuse, in accordance with an embodiment of the present invention; and

FIGS. 2-5 are flow charts that schematically illustrate methods for detecting and mitigating advertisement abuse, in accordance with embodiments of the present invention.

### DETAILED DESCRIPTION OF EMBODIMENTS

### Overview

On-line advertising is used extensively by Content Providers (CPs), and is often considered a major source of revenue. On-line advertisements have various forms, such as banners and images displayed when viewing Web pages, video advertisements displayed with video content, among others.

The business viability of on-line advertising, however, is threatened by various types of advertisement abuse software, which runs on the user device and illegitimately manipulates advertisements. Examples of ad abuse software include Ad Blocking Software (ABS) that blocks the display of advertisements, and ad Hijacking and Injection Software (HIS) that causes the user device to display illegitimate advertisements that do not originate from the legitimate CP. Ad abuse software causes considerable financial and other damage to CPs.

Embodiments of the present invention that are described herein provide improved methods and systems for detecting and mitigating the abuse of ads in digital documents. The disclosed techniques protect the interests of CPs and prevent the potential damage caused by ad abuse.

In some embodiments, a content server serves digital documents (e.g., Web pages or video streams) to user devices (e.g., computers or smartphones). A served document comprises content, at least one advertisement, and an embedded executable code that tests whether ad abuse software runs on the user device. In other embodiments, the executable code is provided to the user device in advance, separately from a specific document.

In an example embodiment, the code tests whether the advertisement is indeed displayed as specified. If the test detects ad abuse, the executable code takes responsive actions such as ensuring that the advertisement is displayed properly. Various tests of varying complexities for detecting the presence of ad abuse software are described herein. Some types of ad abuse software use measures to evade detection, and some of the disclosed tests are designed to overcome these measures.

In some embodiments, the served document comprises an additional alternative advertisement that is embedded in the document in a manner that is undetectable by the ad abuse software. Upon detecting that the default advertisement was blocked, the executable code causes the user device to display the alternative advertisement.

In other embodiments, the document specifies that the default advertisement and the alternative advertisement are both displayed to begin with. In these embodiments, if the executable code finds that the default advertisement was blocked, it does nothing and thus allows the alternative advertisement to be displayed. If no ad abuse is detected, the executable code inhibits the alternative advertisement.

Various techniques for embedding the alternative advertisement in the document in an undetectable manner are described herein. In alternative embodiments, the default advertisement is embedded in an undetectable manner in the first place, in which case the document does not comprise the executable code or the alternative advertisement. This configuration is useful, for example, when a single entity serves as both content provider and advertisement provider, or when ads are fetched in a server-side configuration, as opposed to client-side configuration.

Yet another family of disclosed techniques detect and mitigate advertisement hijacking and injection, i.e., display of rogue advertisements. A Single Sign-On (SSO) subscription service, which allows registered users to receive advertising-free documents across multiple CPs, is also described.

The methods and systems described herein detect and mitigate various kinds of advertisement abuse with high reliability and, in most implementations, using modest-size client-side code. Many of the disclosed techniques do not make any assumptions as to the specific techniques used by the ad abuse software, and are therefore highly effective against unknown types of ad abuse software or unknown modes of operation. Moreover, the disclosed techniques operate on the digital documents regardless of where the ad abuse takes place. This feature makes these techniques effective, for example, even against ad abuse performed by intermediary entities such as Internet Service Providers (ISPs).

### System Description

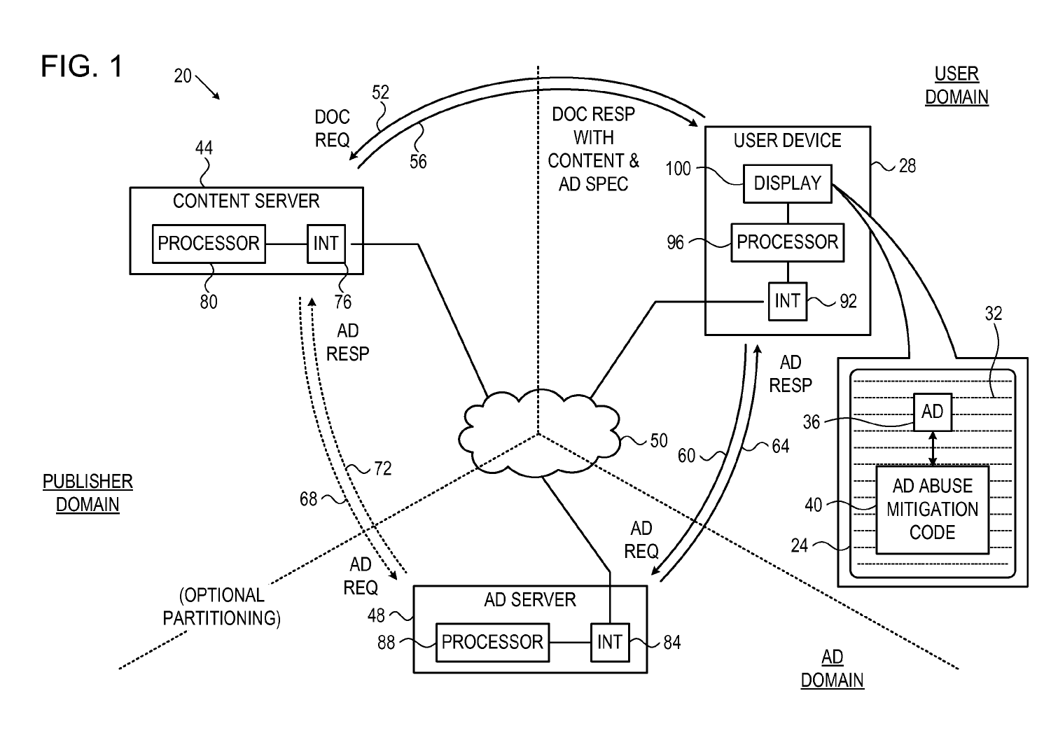

FIG. 1 is a block diagram that schematically illustrates a system 20 for detecting and mitigating advertisement abuse, in accordance with an embodiment of the present invention. System 20 serves digital documents 24 for display on user devices 28. Documents 24 may comprise, for example, Web pages such as Hypertext Markup Language (HTML) files or video streams. User devices 28 may comprise, for example, personal computers, mobile computing devices such as tablets or smart-phones, or any other suitable user device. Alternatively, however, the disclosed techniques can be used with various other kinds of digital documents and user devices.

A typical digital document 24 comprises content 32, which may comprise various elements such as text, still or video images, or any other suitable type of content. In addition, document 24 may comprise one or more advertisements (ads) 36 that are served for display on user device 28 to the user along with content 32.

In practice, however, user device 28 potentially runs advertisement abuse software that tampers with ad 36 and prevents it from being displayed as specified. The ad abuse software may comprise, for example, Ad-Blocking Software (ABS) that prevents the display of ads, software that replaces ad 36 with a rogue advertisement (a technique referred to as “ad injection,” “white spacing” or “ad hijacking”), or any other kind of software that tampers with the specified display of ad 36 on user device 28.

In some embodiments that are described in detail below, document 24 comprises ad abuse mitigation code 40—Executable software code that is embedded in document 24 for detecting and mitigating ad abuse. In alternative embodiments, code 40 is downloaded in advance to user device 28 separately from document 24. The embodiments described below refer mainly to ad abuse mitigation code that is embedded in the document, but the disclosed techniques are applicable in a similar manner to separately downloaded ad abuse mitigation code. The functionality of the executable code is similar, regardless of the way in which it is delivered to the user device.

Code 40 runs on user device 28 and verifies whether the user device runs ad abuse software such as ABS. Typically, when document 24 is displayed, code 40 verifies whether or not ad 36 has been tampered with by ad abuse software. Based on this verification, code 40 takes appropriate measures for mitigating the ad abuse, e.g., for ensuring that ad 36 is displayed properly. Various techniques that can be used by system 20 for detecting and mitigating ad abuse are described below. Some of these techniques, although not all, use code 40.

As noted above, code 40 may be embedded in document 24 or provided to user terminal 28 in advance. When code 40 is embedded in document 24, the code may be written, for example, in JavaScript or other client-side languages (e.g., VB Script, Google DART), in a framework language such as Flash, Java or .NET, or in any other suitable software language. When code 40 is downloaded separately from the document, the code may be written in any suitable language.

Code 40 may be embedded in document 24 in various ways, such as by embedding the code in the HTML or application, calling the document from the document (e.g., using AJAX or other mechanism), caching the code locally (e.g., using browser caching, HTML 5 local storage, cookies, flash storage or other means).

System 20 may be implemented using various system configurations, which vary depending on technological considerations as well as business models. FIG. 1 shows one example configuration, but the disclosed techniques are in no way limited to this configuration.

In FIG. 1, system 20 is distributed across three domains that are operated by different entities: A publisher domain corresponding to content providers (CPs, also referred to as publishers), a user domain corresponding to the end users (also referred to as clients), and an ad domain corresponding to ad providers. As will be explained further below, the separation between the publisher domain and the ad domain is optional, and these two domains may be joined in some configurations.

In the present example, system 20 comprises a content server 44 that serves digital documents to user devices 28, and an ad server 48 that serves advertisements that are displayed as part of the documents. In an example process flow, user device 52 sends a document request 52 to content server 44, requesting document 24. The content server responds to the document request with a document response 56. The document response comprises document 24 including, for example, content 32. In addition, the served document specifies ad 36 that is to be displayed with the document, e.g., the address in ad server 48 from which ad 36 should be fetched and various display parameters for the ad. Using this specification, user device 28 sends an ad request 60 to ad server 48. The ad server responds with an ad response 64 that serves the requested ad. The user device then displays the digital document, including content 32 obtained from server 44 and ad 36 obtained from server 48.

In an alternative flow (shown on the left-and-side of the figure with dashed arrows), the embedding of ad 36 in document 24 is performed in content server 44 before sending the document to user device 28. In this flow, upon receiving document request 52, content server 44 sends an ad request 68 to ad server 68 and receives ad 36 in an ad response 72. The content server combines the ad in document 24 and serves the document (in document response 56) to user device 28.

In yet another possible configuration, a single entity (publisher) serves as both content provider and ad provider. In such a configuration, document 24 is initially generated with both content 32 and ad 28. In this embodiment the functions of content server 44 and ad server 48 may be implemented in a single server.

In the embodiment of FIG. 1, content server 44, ad server 48 and user device 28 communicate with one another over a network 50. Network 50 may comprise, for example, the Internet, an Intranet of an enterprise, a public wireless network such as a cellular network, or any other suitable network or combination of networks.

In this embodiment, content server 44 comprises a network interface 76 that is configured to communicate over network 50, e.g., for serving documents to user devices, and a processor 80 that carries out the various processing functions of the content server. Ad server 48 comprises a network interface 84 that is configured to communicate over network 50, e.g., for serving ads to user devices or to the content server, and a processor 88 that carries out the various processing functions of the ad server. User device 28 comprises a network interface 92 that is configured to communicate over network 50, a processor 96 that carries out the various processing functions of the user device, and a display 100 that displays documents 24 to the user. Processor 96 typically runs a suitable browser or reader that processes and displays digital documents.

As noted above, the system configuration of FIG. 1 is an example configuration that is chosen purely for the sake of conceptual clarity. In alternative embodiments, any other suitable system configuration may be used. The figure shows a single content server, a single ad server, a single user device, a single document and a single ad, for the sake of clarity. Real-life systems may well comprise pluralities of each of these elements.

The various elements of system 20 may be implemented in hardware, in software, or using a combination of hardware and software elements. Typically, processors 80, 88 and 96 comprise general-purpose processors, which are programmed in software to carry out the functions described herein. The software may be downloaded to any of these processors in electronic form, over a network, for example, or it may, alternatively or additionally, be provided and/or stored on non-transitory tangible media, such as magnetic, optical, or electronic memory.

### Detecting and Mitigating Ad Abuse Using Executable Code Embedded in Document

As explained above, in some embodiments document 24 served from content server 44 comprises embedded executable code 40, which detects and mitigates possible abuse of ad 36 by ABS or other ad abuse software. In other embodiments the code is downloaded in advance to the user device.

In some embodiments, code 40 checks whether ad 36 is displayed in user device 28 as specified. If not, code 40 displays an alternative ad that is provided in document 24. In an example embodiment, the alternative ad is embedded in the document using a format that is indistinguishable from content, and therefore undetectable by the ABS that blocked ad 36.

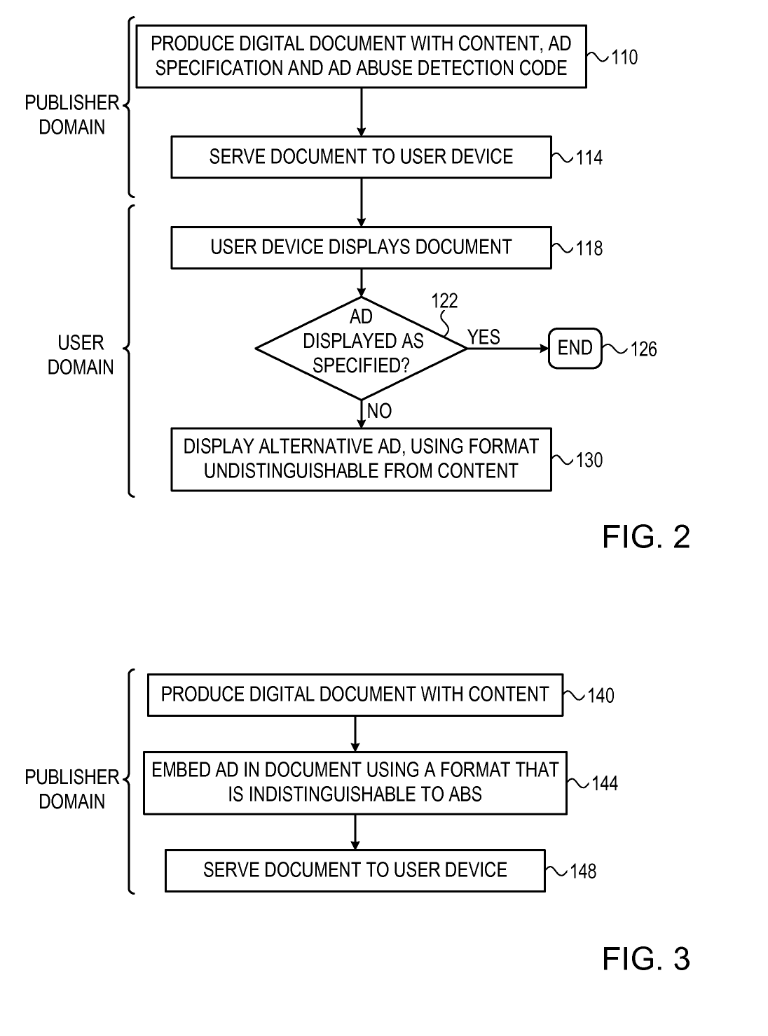

FIG. 2 is a flow chart that schematically illustrates a method for detecting and mitigating advertisement blocking, in accordance with an embodiment of the present invention. The method begins with processor 80 of content server 44 producing digital document 24, at a document generation step 110. The document comprises content 32, a specification of ad 36, and abuse mitigation code 40. Content server 44 serves the document over network 50 via interface 76 to user device 28, at a document serving step 114.

Processor 96 of user device 28 receives document 24 via interface 92, and displays the document to the user on display 100, at a displaying step 118. For this purpose, processor 96 may fetch ad 36 from ad server 48 based on the ad specification that is supplied as part of the document.

Code 40 executes on processor 96 when document 24 is displayed. Code 40 checks whether ad 36 is displayed as specified, at an ad checking step 122. If so, the method terminates at a termination step 126. If not, code 40 concludes that ad 36 was blocked by an ABS running on processor 96, and in response displays an alternative ad, at an alternative display step 130.

In some embodiments, code 40 tests one or more test elements in document 24 in order to detect whether or not ad 36 is displayed as intended. The test elements may be added to the document for purpose of ABS detection. Alternatively, code 40 may choose test elements that are present in the document regardless of ABS detection. Examples of test elements may comprise:
An element that attempts to connect to a known ad server (for example www.doubleclick.com).
A flash (.SWF) element (since some ABS block all flash content).
Elements of a specific size.
Elements containing specific content.
Elements located in a specific location within the document (e.g., first DIV element within an HTML Document Object Model (DOM)).
Elements of a specific type (e.g., all IFRAME elements in an HTML document).
Elements having specific properties (e.g., all HTML elements whose CLASS property is equal to “advertisement”).
A unique identifier that encompasses a multitude of identifiers comprising, for example, time, document name or address, top-level domain, user identifiers, ad type, format, size and/or advertiser. The information may be encrypted.
A global variable that only exists or receives a valid value upon successful loading of an advertisement element, or other parties such as ad network, ad exchanges, Demand Side Platforms (DSPs), Sell Side Platforms (SSPs), Data Management Platforms (DMPs), and/or verification and analytics companies.
Outgoing communication requests and responses (for example calls to a known ad-server).

Code 40 typically verifies whether the test elements function as intended (e.g., whether an image element in the HTML DOM has the expected size, whether a function located in a script file is defined, or whether a connection was opened to an ad server). Detecting an abnormality in a test element may indicate that an ABS runs in user device 28, and therefore that ad 36 may have been blocked.

In some embodiments, a test element and/or test depends on the user device type or version. For example, if the browser type is Mozilla FireFox, and a test element failed in connecting to a well-known ad server address, code 40 may infer that the user device runs the Ad-Block Plus ABS (assuming it is known that Ad-Block Plus is the only ABS available for FireFox that uses this specific blocking technique).

The test elements and tests described above are chosen purely by way of example. Additionally or alternatively, code 40 may test any other suitable test element using any other suitable test.

Upon detecting that ad 36 has been blocked by an ABS, code 40 serves an alternative ad specification in a way that is undetectable by the ABS. The alternative ad specification is typically formatted in such an undetectable manner in document 24 by content server 44. The family of techniques disclosed herein is referred to as “dynamic structuring.” Dynamic structuring techniques typically apply frequent modifications to the attributes of document elements relating to the alternative ad, for example on every access to the document.

Dynamic structuring is effective against ABSs that detect ads using a certain set of detection rules—Currently the vast majority of available ABSs. The frequent changes make it difficult or impossible for the ABS to update its rules adaptively. As a result, the ABS is unable to distinguish the alternative ad specification from content 32. Examples of dynamic structuring techniques comprise:
Frequently changing the location of an element within a content structure document in document 24. A content structure document is a document describing properties and functionality of elements that are grouped together. In HTML, for example, the content structure document is the DOM. An example of an element location change in the DOM would be to randomly select a visible DIV element in the DOM and place the advertisement element as its last child.
Frequently changing the structure type of an element, for example switching between A, SPAN and DIV HTML elements to represent the advertisement.
Frequently changing the initial element properties, for example changing the values of the Height and Width properties of an IMG HTML element.
Splitting document elements (e.g., images) into distinct sub-parts that are only united in the document.

In alternative embodiments, content server 44 may use any other suitable dynamic structuring technique or combination of techniques.

In some embodiments, the content server takes additional measures for preventing the dynamic structuring from damaging the appearance of the alternative ad to the user. Typically, the content server provides additional display properties that ensure correct and consistent appearance of the ad. For example, in an HTML document, if the original position or type of an element in the DOM was changed by dynamic structuring, the element can nevertheless be set using Cascading Style Sheets (CSS) to appear as originally intended. These changes are potentially adapted per each unique set of selected ad element identifiers.

Additionally or alternatively, content server 44 may embed the alternative ad specification in a manner that prevents the ABS from detecting the communication with ad server 48. These techniques, referred to herein as “communication masking,” are effective against ABSs that block the communication between the user device and the ad server. Communication masking techniques may comprise, for example:
Embedding the ad in the CP's content (e.g., embedding image data directly in an IMG HTML element using Base64 encoding: <img src=“data:image/png;base64,iVBORw0KGgoAAAANS . . . ”/>).
Delivering the ad from a network address that is not currently listed in the address list known to the ABS. The network address may comprise, for example, any combination of a URL, Host Name, Domain Name, IP address, Communication Protocol and Port. To avoid listing the new network address, it should be changed periodically, possibly requiring registration with a network administration agency (e.g., constantly registering new domain names). Alternatively, the network address may be created randomly in real-time (e.g., by creating a random host name under the domain name of the CP, such as v0si93ki3.contentprovider.com). The network address may optionally be selected from a group of available addresses. This list may be embedded in the CP's content itself in clear text or obfuscated form, retrieved from a remote location by the user device, retrieved from the content server by the user device, or located in any other suitable location.
Ensuring that the network addresses of the ad resources are structurally indistinguishable from other content resources. One way of implementing this feature is to upload the ads to the standard image directory of the CP, allowing them to be retrieved from URLs similar to those of other images of the CP.
Ensuring that the network addresses of the ad resources are structurally indistinguishable from other content resources by mapping the addresses of all content resources (addresses of type A) and of all alternative ad resources (addresses of type B) to addresses of a new type (type C), displaying Type C addresses in the content sent to the user device, and mapping the requests to addresses of type C from the user device to the content behind the mapped addresses of types A and B in the server.

An example of the latter technique may comprise:
The original content document references a content element under the URL http://website.com/images/123.jpg (type A) and an advertisement element under the URL http://website.com/ads/discounts.jpg (type B).
Before serving the content to the user-device, the first URL is mapped to http://website.com/resources/1.jpg and the second is mapped to http://website.com/resources/2.jpg (both type C and structurally indistinguishable), and the original URLs of types A and B are overridden with the new type C URLs in the content document sent to the user device.
When a request to http://website.com/resources/1.jpg (type C) is received by the content server, the resource at http://website.com/images/123.jpg (type A) is returned.
When a request to http://website.com/resources/2.jpg (the mapped type C address) is received by the content server, the resource at http://website.com/ads/discounts.jpg (the mapped type A address) is returned.

In an embodiment, the choice of alternative ads (which are served upon detection of an ABS) can be targeted to target audiences that are known to use ABS, for example to a more technologically-savvy audience. More generally, the information as to ABS presence or absence can be used to infer demographic information regarding the users. Such demographic information can later be used for various purposes, such as for content personalization and retargeting.

In some embodiments, upon detecting that ad 36 has been blocked at step 122 above, code 40 initiates displaying a message from the CP that requests the user to switch off the ABS. Furthermore, code 40 may initiate any other suitable action in response to detecting that ad 36 has been blocked, instead of or in addition to serving the alternative ad.

In the examples above, the detection of ad abuse software and the corrective action are both applied to the same document. In alternative embodiments, detection of ad abuse software may be performed in one document, and the resulting corrective action may be applied in a different document. As explained above, in alternative embodiments the detection and/or mitigation of ad abuse software is performed by code that is downloaded in advance separately from a specific document.

### Advanced Tests for Detecting Ad Abuse Software

Typically, ad abuse software operates in accordance with a dynamic list of rules that specify the document elements that are to be blocked or otherwise abused. Such a list may comprise, for example, a rule that instructs not to retrieve any URL containing the string “/doubleclick.js” (which is likely a call to communicate with a known ad provider). As another example, the string “##div[class=”advertisement“]” specifies removal from the HTML document of any “div” tag whose class attribute is “advertisement” (most likely to contain an advertisement). Rules of this sort may apply to all content regardless of source, or they may be customized to a specific CP or URLs.

In many practical scenarios, the ad abuse software attempts to avoid being detected (and then potentially disabled) by selectively disabling one or more of its rules, possibly per site. In some embodiments, code 40 performs advanced tests, which detect the presence of ad abuse software in spite of such evasion attempts. Note, however, that the tests described below improve the performance of code 40 in various other scenarios, not necessarily related to evasion attempts of the ad abuse software.

For example, code 40 may store the results of various tests locally on user device 28, using cookies or other local storage means. Code 40 may access the locally stored test results as needed. This capability enables code 40 to decide whether the user device runs ad abuse software, based on test results taken over multiple previous documents and/or at multiple points in time. Such a composite test, which is based on multiple individual tests, is considerably more reliable and less susceptible to evasion attempts. In alternative embodiments, code 40 may store test results externally to the user device, e.g., on a remote site.

For a given individual test, the test results that are stored locally on the user device may comprise any suitable information, such as, for example:
Test type (e.g., element hiding) and the specific test performed (e.g., injected DIV of class property value “ad”).
Values or properties for at least one more element in the document (e.g., the height value of another element).
Time-of-day
User details (e.g., IP address, country, DMA, sex, operating system, browser type).
Interaction with other content document element (e.g., mouse hover on a specific element).

In an embodiment, code 40 queries the locally-stored test results of multiple individual tests, and applies certain decision logic to the results in order to decide whether the user device runs ad abuse software or not. Any suitable decision logic can be used.

The decision logic of code 40 may operate independently, e.g., using predefined rules and based solely on information that is stored locally on user device 28. Alternatively, the decision logic may communicate with remote entities such as a Web service in order to adapt its rules or query additional information (e.g., test results of other user devices).

The decision logic may consider various factors in making the decision. Such considerations may include, for example:
Binary tests, which are sufficient by themselves to identify the user device as either using or not using ad abuse software, regardless of other results.
Grouped tests, in which at least two individual test results, or one test result taken at two separate points in time, identify the user device as either using or not using ad abuse software.
The probability of detection of at least one test.
The existence of at least one previous saved test.

In some embodiments, the decision logic of code 40 may apply additional mechanisms against evasion attempts of the ad abuse software. Such mechanisms may comprise, for example:
Tracking of changes in detection decisions. Such a mechanism may track events in which user devices for which a given test previously produced a given result and later began to produce a different result. This sort of events may be indicative of a change in the rule list of the ad abuse software.
Detection protection/decay: In such a mechanism, a user device in which a previous result of a given test was positive (i.e., ad abuse software was detected) will continue to be marked by code 40 as positive for a certain time period even if subsequent test results are negative.
Detection sub-grouping: In this sort of mechanism, code 40 will apply certain detection criteria to user devices based on a specified parameter (e.g., screen resolution, IP address or user device type).

In alternative embodiments, code 40 may use any other suitable decision logic and any other suitable tests to detect operation of ad abuse software.

### Mitigating Ad Abuse by Serving Ads Undistinguishable from Content

In the embodiments described above, an alternative ad specification is served upon detection of an ad abuse software. The alternative ad is embedded in the document using an undistinguishable format, e.g., using dynamic structuring or communication masking.

In other embodiments, content server 44 uses such an undetectable format to embed the originally-displayed ad in the document. In these embodiments, the document typically does not comprise code 40 or an alternative ad. User device 28 receives the document with the embedded ad from the content server, and displays it to the user.

FIG. 3 is a flow chart that schematically illustrates a method for mitigating advertisement abuse, in accordance with an embodiment of the present invention. The method begins with processor 80 of content server 44 producing a digital document comprising content, at a document generation step 140. Processor 80 embeds an ad in the document using a format that is undetectable by the rules used by known ABSs, at an ad embedding step 144. Processor 80 serves the document, with the embedded ad, to user device 28 via interface 76, at a document serving step 148.

The embodiment above is particularly suitable for business models and system configurations in which a single entity serves as both content provider and ad provider. Nevertheless, this implementation can be used in other configurations, as well.

### Mitigating Ad Blocking Using Positive Detection

In some embodiments, system 20 mitigates ad abuse by simultaneously serving two advertisements for the same location in a given document—A regular ad and an alternative ad. The alternative ad is typically formatted in a manner that is undetectable by ABS, such as using the dynamic structuring schemes explained above. By default, both ads are displayed.

In this embodiment, code 40 checks for correct display of the regular ad (unlike the previous embodiments in which code 40 checks for improper display of the regular ad). If the regular ad is found to be displayed correctly, code 40 inhibits the display of the alternative ad and thus allows the regular ad to be displayed. Otherwise (i.e., if the regular ad was blocked), code 40 does nothing and allows the alternative ad to be displayed.

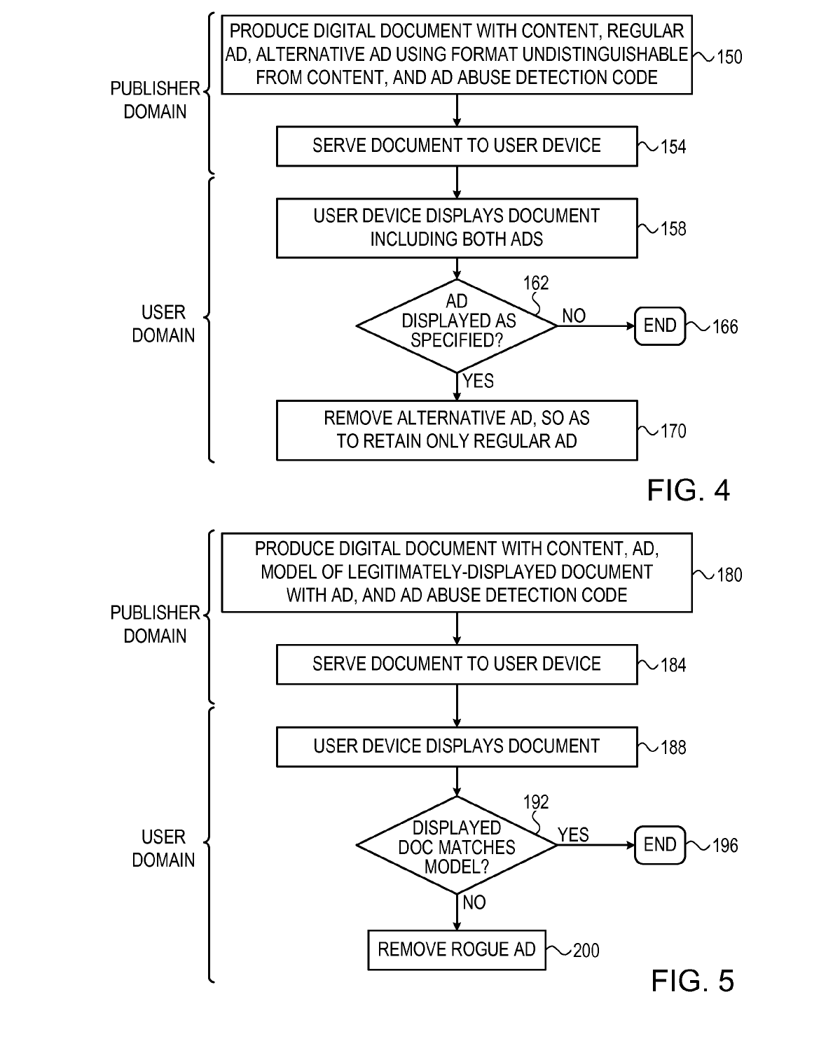

FIG. 4 is a flow chart that schematically illustrates the above-described method for detecting and mitigating advertisement abuse, in accordance with an embodiment of the present invention. The method begins with processor 80 of content server 44 producing digital document 24, at a document generation step 150. The document comprises content 32, a specification of regular ad 36, a specification of an alternative ad using dynamic structuring, and abuse mitigation code 40. Content server 44 serves the document over network 50 via interface 76 to user device 28, at a document serving step 154.

Processor 96 of user device 28 receives document 24 via interface 92, and displays the document to the user on display 100, at a displaying step 158. In this embodiment, both the regular ad and the alternative ad are displayed by default.

Code 40 in document 24 checks whether regular ad 36 is displayed as specified, at a display checking step 162. Any of the tests described herein can be used for this purpose. If the test concludes that the regular ad is not displayed as specified, code 40 terminates the method at a termination step 166. As a result, the alternative ad is displayed to the user. Otherwise, i.e., if the test concludes that the regular ad is displayed as specified, code 40 inhibits display of the alternative ad, at an inhibiting step 170. As a result, the regular ad is displayed to the user.

This sort of logic makes it useless for the ad abuse software to try and evade the tests of code 40: An evaded test (i.e., a failure of code 40 to detect ad blocking) will simply cause code 40 to refrain from inhibiting the alternative ad, which is against the interest of the ad abuse software.

### Detecting and Mitigating Ad Hijacking and Injection

Another type of ad abuse is referred to as ad hijacking, white spacing or ad injection. Software that performs such functions in user device 28 is sometimes referred to as Hijacking and Injection Software (HIS). Examples of HIS include 50on Red, Sambreel and SuperFish. A HIS typically alters digital documents that are served to the user device, and illegitimately inject elements such as ads without knowledge or consent of the legitimate CP.

A HIS may, for example, inject an unauthorized advertisement into the displayed document, display rogue search results that redirect the user to a search results page owned by the HIS, display unauthorized product recommendations or price comparisons, inject advertisements disguised as content, or perform various other illegitimate display of document elements. A HIS may also violate user privacy, e.g., retrieve user information without explicit permission and later use the information for re-targeting ads or other uses.

HISs often evade detection by modifying their operation based on various factors such as the presence of another HIS, the identity of the CP, the user device geographical location (for example via his IP address), the user device configuration (for example device type, browser version, operating system or screen resolution), or a random functional element operating from the user computer or a remote computer.

In some embodiments, code 40 detects and mitigates hijacking and injection of ads by checking the displayed document against a model of a legitimate document. If the displayed document does not match the model, code 40 concludes that the document was manipulated by HIS, and takes appropriate action to remove the illegitimate ad.

FIG. 5 is a flow chart that schematically illustrates a method for detecting and mitigating advertisement hijacking or injection, in accordance with an embodiment of the present invention. The method begins with processor 80 of content server 44 producing digital document 24, at a document generation step 180. The document comprises content 32, a specification of ad 36, a model of legitimately-displayed document 24, and abuse mitigation code 40.

The model of the legitimately-displayed document may comprise any suitable model that enables code 40 to decide whether the document is displayed correctly or whether it was tampered with by HIS. In one embodiment, the model comprises a “white-list” of document element descriptors that, when found, indicate that the displayed elements are legitimate. The white-list may be prepared in advance, e.g., manually, or generated automatically from document 24 in the content server. The descriptors may be specified explicitly or implicitly, e.g., using wildcard characters or regular expressions. Additionally or alternatively, the descriptors may comprise additional identifiers such as internal content.

For example, the following descriptors can be used with reference to a DOM of an HTML document:
HTML Tag element of type DIV with Class property value of ‘header’ and internal content equal to ‘32″ Television: $99.99’.
HTML Tag element of type ‘ul’.
JavaScript function of title ‘MainLoader’.
HTML Tag element of type A with Src property value starting with ‘http://www.google.com’.
CSS class of name ‘MainHeader’.
CSS class of name ‘MainHeader’ that includes .color property value equal to ‘red’.

In alternative embodiments, the model may comprise a signature of the legitimate document, such as a Cyclic Redundancy Check (CRC) or a compressed version of the document. Further alternatively, the model may have any other suitable structure.

Content server 44 serves the document over network 50 via interface 76 to user device 28, at a document serving step 184. Processor 96 of user device 28 receives document 24 via interface 92, and displays the document to the user on display 100, at a displaying step 188.

Code 40 checks whether the displayed document matches the model, at a model comparison step 192. In a white-list implementation, for example, code 40 typically scans the various document elements and verifies that they match the descriptors. If the document is found to match the model, the method terminates at a termination step 196. If not, code 40 concludes that the document was altered by HIS, and takes action to remove the rogue ad, at a removal step 200.

Code 40 may take various actions to remove the rogue ad. In an example embodiment, code 40 removes the entire ad from the document. In an HTML document, for example, the ad may be removed programmatically using JavaScript, e.g., using the elem.parentNode.removeChild(elem) method.

In another embodiment, code 40 hides the rogue ad within the document, thereby preventing its display. In an HTML document, for example, code 40 may hide the rogue ad using CSS by setting the value of the ad's visibility property to ‘none’. In yet another embodiment, code 40 wraps the rogue ad in another document element, which is then hidden. In an HTML document, for example, this action may be performed programmatically using JavaScript, e.g., by wrapping the rogue ad in a DIV tag and hiding the DIV tag as explained above.

In still another embodiment, code 40 programmatically disables and/or interrupts the rogue ad. The decision to disable or interrupt may be taken independently by code 40 or by communication with some remote entity such as a Web service. In an HTML document, for example, code 40 may disable or interrupt the rogue ad by setting an operating variable to a disabling value, by running an operating sub-program with a disabling value, by changing a document property that the rogue ad refers to, by activating a ‘close’ event that exists in the injected rogue ad, by deleting injected programs from the document, or using any other suitable means.

In some embodiments, the legitimate ad is embedded in document 24 in an undetectable manner, such as using the dynamic structuring schemes described above. In these embodiments, code 40 causes the embedded ad to display instead of the rogue ad that was removed.

The disclosed HIS mitigation solutions are highly effective, for example, because they do not make any assumptions as to the mode of operation of the HIS. Therefore, the disclosed techniques are able to respond rapidly to unknown HISs and modes of operation. Moreover, the disclosed techniques can be implemented using modest size client-side code.

### Subscription Service for Advertisement Removal

In some embodiments, system 20 provides a Single-Sign-On (SSO) subscription service for ad removal. Since ad-intolerant users tend to be so across multiple CPs, a SSO service is a useful solution. In this embodiment, when a user registers for the ad-removal service at a participating CP, he is registered in a central user database. The user will be served ad-free versions of digital documents at all participating CPs for which he is admitted.

Such a service may charge a fixed periodic fee, a fee per site visited, a fee per ad removed, or use any other suitable pricing method. An alternative to directly charging the user for ad removal is to have the user perform an action that has value to the CP. Such an action may comprise, for example, endorsing the CP on a social network (e.g., a Facebook like) or downloading third-party software for which the CP receives a fee (e.g., a toolbar).

One method of enabling such a service at a CPs is to use ad-server cascades. Ad-server cascades are queues that define the order in which ad-servers are contacted by the CP to request ads. A CP can thus quickly enable the ad-free SSO service described above by defining it as the first ad-server in the list. This first ad-server will then serve empty ads (e.g., an image having background color or a zero-second length video) if the user is registered in the centralized user database as an ad-free subscriber. If the user is not identified as an ad-free subscriber, the cascade moves on to the next ad-server in the cascade.

Various methods may be used to allow all participating CPs to be able to identify the user. For example:
A third-party cookie that was planted from the SSO service provider's domain and is checked by it on every participating CP.
The user can be offered to install a plug-in to his user device (such as a Firefox Add-on or a Chrome Extension in the case of web browsers) that will plant a recognition token (such as a Header item in the case of web browsers) in all content requests to the participating CPs.

Ad-networks (and other ad systems such as an ad server, an ad exchange, an on-line video platform (OVP) or a sell side platform (SSP)) that serve ads to a wide variety of CPs may also be used to implement an ad-free SSO service. Each time a user connects to a CP that is part of a partnering ad-network, a call is made to the centralized user database with the user's unique identifier. If the user is identified in the main user database as authorized to access the aforementioned CP in an ad-free version, the ad-network will not serve an ad. The ad-network may, for example, directly disable the ad server, serve an empty ad, or refer to an empty ad-server as mentioned above. This method may be also implemented at the ad-server, ad-exchange, online video platform or sell-side platform level.

Provided the above system is implemented by a sufficiently large group of sites, it may be used as an alternative payment system that is not limited to ad-free subscription services. A payment scheme of this sort may apply to various products or services, tangible or intangible. For example, it is possible to use this payment scheme for monetizing premium content, in which every impression the user makes is monitored, counted and accounted for. In an example scheme, the user pays a fixed sum, from which each impression is paid for as a weighted average function.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1-40. (canceled)

41. A system for detecting and mitigating advertisement abuse software on a user device, the system comprising:
one or more processors; and
a non-transitory storage medium comprising executable code for execution by the one or more processors, the executable code configured to:
produce a digital document comprising a specification for a default advertisement and content;
detect, based on a test associated with one or more test elements, advertisement abuse software for preventing the default advertisement from being displayed as specified on the user device;
generate a specification for embedding an alternative advertisement in the digital document, so as to prevent detection by advertisement abuse software; and
facilitate a display of one of the default advertisement and the alternative advertisement on the user device based on whether advertisement abuse software is detected.

42. The system of claim 41, wherein the executable code is further configured to inhibit a display of the embedded alternative advertisement on the user device upon detecting that the user device does not include advertisement abuse software.

43. The system of claim 41, wherein the specification for embedding the alternative advertisement in the digital document is based on a dynamic structuring technique that includes repeatedly modifying an attribute of the alternative advertisement.

44. The system of claim 41, wherein the specification for embedding the alternative advertisement in the digital document is based on a communication masking technique.

45. The system of claim 41, wherein the test comprises determining test results for one or more previous digital documents, wherein the test results include additional information regarding one or more of a test type, test performed, values or properties for at least one non-advertisement element, a time of day, user information and interaction with non-advertisement document elements.

46. The system of claim 41, wherein the test comprises one or more of a binary test, a group test, a determination of a probability of detection of the test, consideration of at least one previous test, tracking of changes in detection decisions, a detection protection/decay mechanism and a detection sub-grouping mechanism.

47. The system of claim 41, wherein the test comprises comparing a display of the digital document with a model of a legitimately displayed version of the digital document, wherein the model includes one or more of an electronic signature and document element descriptors that, when found in the display of the digital document, indicate that the digital document has been legitimately displayed.

48. The system of claim 41, wherein the executable code is further configured to implement an action to hide, disable, interrupt or remove a rogue advertisement from the digital document, thereby preventing a display of the rogue advertisement.

49. The system of claim 41, wherein the executable code is further configured to:
determine if a user of the user device is registered for a Single-Sign-On subscription service for advertisement removal; and
if the user is registered for the Single-Sign-On subscription service, facilitate a display of an advertisement-free version of the digital document on the user device.

50. A method for detecting and mitigating advertisement abuse software on a user device, the method comprising:
producing a digital document comprising a specification for a default advertisement and content;
detecting, based on a test associated with one or more test elements, advertisement abuse software for preventing the default advertisement from being displayed as specified on the user device;
generating a specification for embedding an alternative advertisement in the digital document, so as to prevent detection by advertisement abuse software; and
facilitating a display of one of the default advertisement and the alternative advertisement on the user device based on whether advertisement abuse software is detected.

51. The method of claim 50, further comprising inhibiting a display of the embedded alternative advertisement on the user device upon detecting that the user device does not include advertisement abuse software.

52. The method of claim 50, wherein the specification for embedding the alternative advertisement in the digital document is based on a dynamic structuring technique that includes repeatedly modifying an attribute of the alternative advertisement.

53. The method of claim 50, wherein the specification for embedding the alternative advertisement in the digital document is based on a communication masking technique.

54. The method of claim 50, wherein the test comprises determining test results for one or more previous digital documents, wherein the test results include additional information regarding one or more of a test type, test performed, values or properties for at least one non-advertisement element, a time of day, user information and interaction with non-advertisement document elements.

55. The method of claim 50, wherein the test comprises one or more of a binary test, a group test, a determination of a probability of detection of the test, consideration of at least one previous test, tracking of changes in detection decisions, a detection protection/decay mechanism and a detection sub-grouping mechanism.

56. The method of claim 50, wherein the test comprises comparing a display of the digital document with a model of a legitimately displayed version of the digital document, wherein the model includes one or more of an electronic signature and document element descriptors that, when found in the display of the digital document, indicate that the digital document has been legitimately displayed.

57. The method of claim 50, further comprising implementing an action to hide, disable, interrupt or remove a rogue advertisement from the digital document, thereby preventing a display of the rogue advertisement.

58. The method of claim 50, further comprising:
determining if a user of the user device is registered for a Single-Sign-On subscription service for advertisement removal; and
if the user is registered for the Single-Sign-On subscription service, facilitating a display of an advertisement-free version of the digital document on the user device.

59. A non-transitory computer readable storage medium tangibly storing computer program instructions capable of being executed by a computer processor, the computer program instructions defining the steps of:
producing a digital document comprising a specification for a default advertisement and content;
detecting, based on a test associated with one or more test elements, advertisement abuse software for preventing the default advertisement from being displayed as specified on the user device;
generating a specification for embedding an alternative advertisement in the digital document, so as to prevent detection by advertisement abuse software; and
facilitating a display of one of the default advertisement and the alternative advertisement on the user device based on whether advertisement abuse software is detected.

60. The computer program instructions of claim 59, wherein the alternative advertisement is targeted based on demographic information for one or more known advertisement abuse software users.
